(19) United States
(12) Patent Application Publication
(10) Pub. No.: US 2008/0179854 A1
(43) Pub. Date: Jul. 31, 2008

(54) STEERING TURNTABLE ASSEMBLY

(76) Inventor: Buddy L. Hammond, South Akron, IN (US)

Correspondence Address: BOTKIN & HALL, LLP, 105 E. JEFFERSON BLVD., SUITE 400, SOUTH BEND, IN, 46601, US

(21) Appl. No.: 11/668,662

(22) Filed: Jan. 30, 2007

(51) Int. Cl. B62D 7/00

(52) U.S. Cl. 280/137.506

(57) ABSTRACT

A steering turntable for a wheeled vehicle includes an upper support plate, a lower support plate rotatably supporting steering wheels of a vehicle, and an isolation plate mounted between said upper and lower plates to reduce steering forces required to steer the vehicle, with the isolation plate carrying multiple bearing elements. The isolation plate includes a pair of parallel bearing plates and is provided with multiple registering apertures cooperating with one another to define multiple cavities. Each of the cavities supports a spherical or spheroidal bearing element, and each cavity is defined by a truncated curved surface terminating in openings in the outer surfaces of the bearing plates so that the bearing elements project above their corresponding bearing plates to engage the upper and lower support plates, respectively.

### BACKGROUND OF THE INVENTION

1. Field of the Invention

This invention relates to a steering turntable that supports and facilitates pivoting of the steering wheels of a wheeled vehicle.

2. Description of the Background of the Invention

Relatively small carts, such as baggage carts, carts transporting ground power systems and similar equipment are often used in aircraft ground service operations. Such carts are commonly moved with a towing vehicle, but also may be moved manually for short distances, such as when connecting the cart to the towing vehicle. In either case, it is desirable to minimize the steering effort required. Also, such equipment is normally operated in adverse environments, in which debris may be trapped in the steering mechanism, thus further increasing the steering effort. Finally, this type of equipment not only is used in adverse environments, but also may be abused by workers. Nevertheless, a long service life with minimal maintenance is a customer expectation. A service life of several hundred thousand cycles is expected and desirable.

Prior art designs have incorporated a flat bearing disc in the steering between the interface between the upper support plate (which is attached to the body of the cart) and the lower support plate (which mounts the steering wheel of the cart and which pivots relative to the upper support plate to effect steering). The disc is commonly made of a low friction material, such as polyvinyl chloride plastic. The plastic disc reduces friction but, because relatively large areas on opposite sides of the disc engage the upper and lower support plates, substantial steering effort is still required. Also, the plastic disc tends to trap road debris between the upper and lower plates and causes the latter to bury itself in the bearing plate, thus further increasing steering effort and requiring frequent maintenance to remove the debris. Thrust bearings have also been proposed, but are expensive and complicated.

### SUMMARY OF THE INVENTION

According to the present invention, a steering turntable for a wheeled vehicle includes an upper support plate, a lower support plate rotatably supporting steering wheels of the vehicle, and an isolation plate mounted between said upper and lower plates to reduce steering forces required to steer the cargo carrier, the isolation plate carrying multiple bearing element. The isolation plate includes a pair of parallel plastic bearing plates and is provided with multiple registering apertures cooperating with one another to define multiple cavities. Each of the cavities supports a spherical or spheroidal bearing element, and each cavity is defined by a truncated curved surface terminating in openings in the outer surfaces of the bearing plates. The curved surfaces of the cavities engage the compatibly curved outer surfaces of the bearing elements. Because of the truncation of the apertures, the bearing elements project from the bearing plates a very small distance (0.050″-0.100″) and engage the upper and lower support plates. Because of the limited contact area, steering effort is substantially reduced over the known devices, and the limited contact area permits road debris to fall out. Since the bearing elements are made a relatively hard material, such as steel, they are extremely durable, thus assuring a relatively long service life.

Although the invention has been described with regard to airline service equipment, it is also useful in manufacturing environments.

### BRIEF DESCRIPTION OF THE DRAWINGS

FIG. 1 is an exploded view in perspective of an airline service cart incorporating a bearing isolation plate made pursuant to the teachings of the present invention;

FIG. 2 is a fragmentary view in perspective of the bearing isolation plate and upper and lower support plates used in the cart illustrated in FIG. 1;

FIG. 3 is a view in perspective of the bearing isolation plate of the present invention, with a portion of the upper bearing plate lifted off to illustrate details;

FIG. 4 is a transverse cross-sectional view of the bearing plate of the present invention shown assembled between the upper and lower support plates; and

FIG. 5 is an enlarged, fragmentary, detailed cross-sectional view taken through one of the apertures of one of the bearing plates, with its associated bearing element shown offset from the aperture.

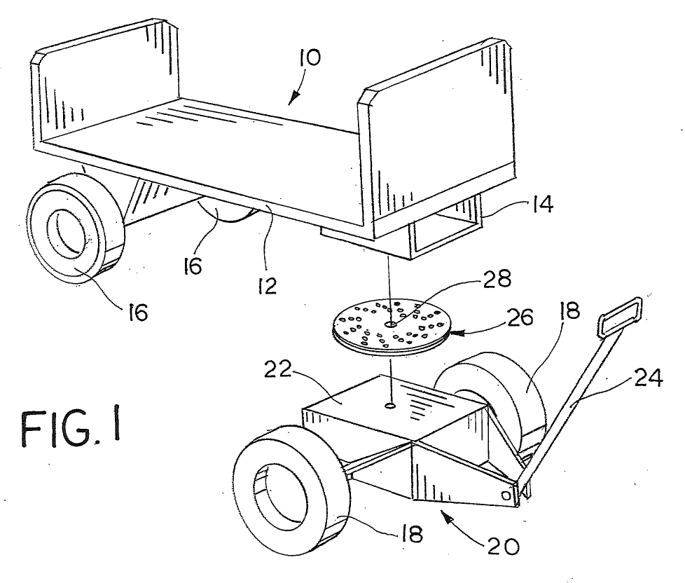

### DETAILED DESCRIPTION OF INVENTION

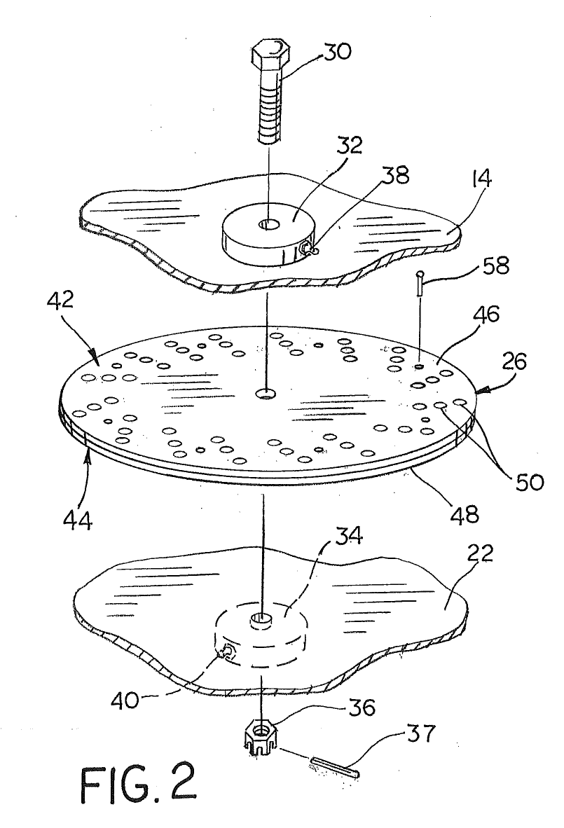

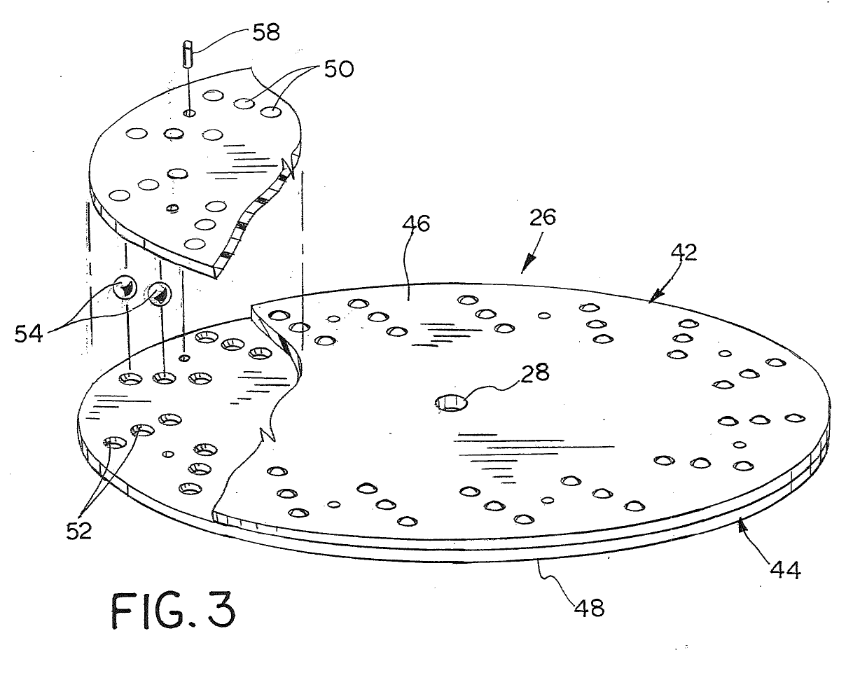

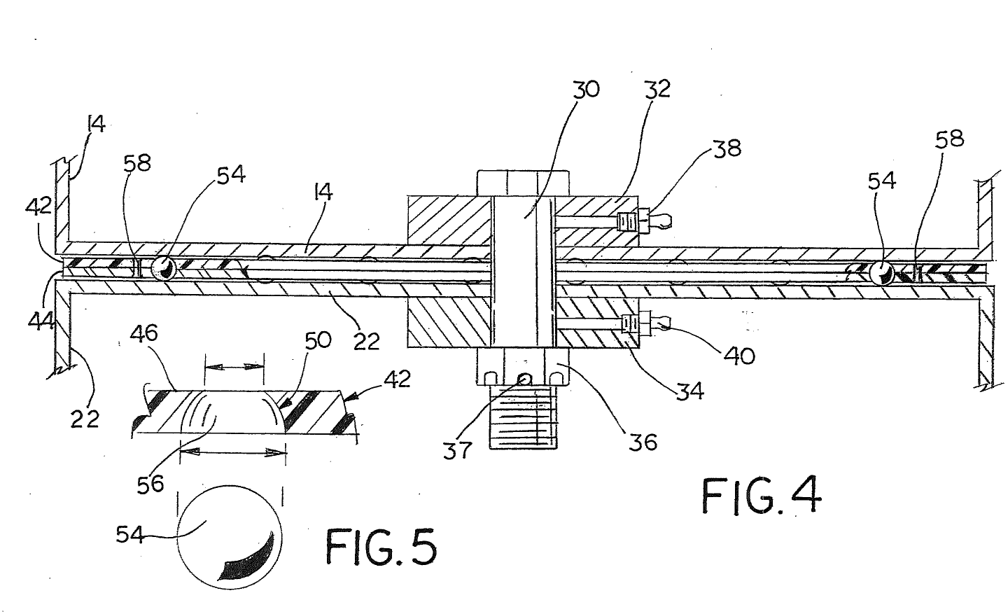

Referring now to the drawings, a typical airline service cart is generally indicated by the numeral 10 and includes a body 12 having an upper support plate 14. The body 12 is supported by rear wheels 16 and front steerable wheels 18, which are a part of a steering assembly generally indicated by the numeral 20. The steering assembly 20 includes a lower support plate 22 and a tongue 24. An isolation bearing plate generally indicated by the numeral 26, which is made pursuant to the teachings of the present invention, includes a central opening 28 and is mounted between the support plates 14, 22. A kingpin 30 (FIGS. 2 and 4), which may be a bolt having threads, extends through an upper reinforcing plate 32 which is mounted on the upper support plate 14 and reinforces it, the upper support plate 14, the central opening 28 of isolation plate 26, the lower support plate 22, and a lower reinforcing plate 34, which is mounted below lower support plate 22 and reinforces it. A castellated nut 36 is threaded on the kingpin 30 and is normally locked in place by a conventional cotter pin 37. Conventional zerk grease fittings 38, 40 are provided in the upper and lower reinforcing plates 32, 34 for lubricating the kingpin 30 in a manner well known to those skilled in the art. Accordingly, the kingpin 30 defines the steering axis of the service cart 10.

The isolation plate 26 includes two parallel bearing plates or discs 42, 44, which are preferably made of plastic or a similar material. The bearing plates 42, 44 extend parallel to one another and to the upper and lower support plates 14, 22 when the isolation plate 26 is installed on the kingpin 30 between the upper and lower support plates 14, 22 as illustrated in FIG. 4. Each of the bearing plates 42, 44 defines an outer surface 46, 48 which faces its corresponding upper or lower support plate 14, 22. Each of the bearing plates 42 44 is provided with multiple apertures 50, 52. The apertures 50,52 in each of the bearing plates 42, 44 are offset from one another both radially and circumferentially, but are located such that the apertures in one of the bearing plates 42, 44 register with the apertures in the other plate to define a cavity receiving a bearing element 54, which is preferably either spherical or spheroidal and made of a relative hard material, such as steel.

The apertures 50, 52 are substantially identical, so only the apertures 50 will be described in detail, referring to FIG. 5. The apertures are defined by a truncated curved surface 56 which terminates in an opening in the outer surface 46 of the bearing plate 42. The curved surface 56 is curved to be compatible with the outer circumferential surface of the bearing elements 54, when the bearing elements 54 are installed in the cavities defined by the registering apertures 50, 52 when the bearing plates 42, 44 are joined together as will hereinafter be explained. Although each of the bearing elements 54 is engaged by the surface 56, a portion of each bearing element 54 will project through the aperture 50 in outer surface 46 and extend above the outer surface 46 of the bearing plate 42. Similarly, a circumferentially opposite portion of the bearing element 54 will project through the aperture 52 in outer surface 48 and extend above the outer surface 48 of the bearing plate 44. Preferably, the apertures 50, 52 and the bearing elements 54 are chosen such that the bearing elements 54 project above corresponding surfaces 46, 48 by about 0.050″-0.100″. The bearing plates 42, 44 are secured together by rivets or other suitable fasteners 58. Alternatively, the bearing plates 42, 44 may be secured together by sonic welds.

The isolation bearing plate 26 is manufactured by first forming the bearing plates 42, 44 and then forming the apertures 50, 52 by conventional ball-end milling techniques. The bearing elements 54 are then installed in the apertures 50, 52 formed in one of the bearing plates 42, 44, and the other bearing plate is placed over the bearing plate in which the bearing elements 54 are located and moved into the position in which the apertures 50, 52 are brought into registry so that the bearing elements 54 are received within the cavities defined by the registering apertures of both bearing plates 42, 44. The rivets 58 are then installed to join the bearing plates 42, 44 together, with the bearing elements 54 trapped in the cavities defined by the registering apertures 50, 52. When the service cart 10 is assembled, the central opening 28 of the assembled isolation plate 26 is installed over the kingpin 30 after the latter has been installed through the upper support plate 14.

It will be noted that in the completed assembly, the portions of the bearing elements 54 projecting above the outer surfaces 46, 48 of the bearing plates 42, 44 will slidably engage their corresponding upper or lower support plates 14, 22. However, the sum of the areas engaged by each of the bearing elements 54 with corresponding upper and lower support plates 14, 22 will be relatively small as compared to prior art designs, which use a plastic bearing plate, the entire area of which engages the support plates. Accordingly, the steering effort required in the present invention is correspondingly reduced. Furthermore, the sliding engagement of the bearing elements 54 with the upper and lower support plates 14, 22 is relatively tight, thereby preventing debris from being trapped between the bearing elements and their corresponding upper and lower support plates 14, 22. Any debris that does accumulate in the open areas between the bearing elements 54 and the upper and lower support plates 14, 22 will be quickly swept out during normal operation of the device. Furthermore, the steel-on-steel engagement of the bearing elements 54 with the upper and lower support plates 14, 22 results in increased service life as compared to older designs in which bearing plates of plastic or a similar softer material were used.

From the above description, it will be apparent that the invention disclosed herein provides a novel and advantageous system for a steering turntable assembly. The foregoing discussion discloses and describes merely exemplary embodiments of the present invention. As will be understood by those familiar with the art, the invention may be embodied in other specific forms and utilize other materials without departing from the spirit or essential characteristics thereof. Accordingly, the disclosure of the present invention is intended to be illustrative, but not limiting, of the scope of the invention, which is set forth in the following claims.

What is claimed is:

1. Steering turntable for a wheeled vehicle, comprising:
an upper support plate;
a lower support plate rotatably supporting steering wheels of said vehicle;
a kingpin connecting the upper and lower support plates and defining a steering axis permitting the lower plate to pivot relative to the upper plate to thereby permit said steering wheels to pivot and thereby effect steering of the vehicle; and
an isolation plate mounted between said upper and lower plates to reduce steering forces required to steer the vehicle, said isolation plate carrying multiple bearing elements.

2. Steering turntable as claimed in claim 1, wherein said isolation plate has opposite sides each facing a corresponding one of said upper and lower support plates, said bearing elements engaging said upper and lower support plates.

3. Steering turntable as claimed in claim 2, wherein said bearing elements project from opposite sides of said isolation plate to engage said upper and lower support plates.

4. Steering turntable as claimed in claim 3, wherein said bearing elements are spheroidal bearing elements.

5. Steering turntable as claimed in claim 2, wherein said isolation plate includes a pair of parallel bearing plates each bearing plate extending parallel to the other bearing plate and to said upper and lower support plates, each of said bearing plates defining an outer surface facing its corresponding upper or lower support plates and further defining multiple registering apertures cooperating to define corresponding multiple cavities, each of said cavities supporting a bearing element.

6. Steering turntable as claimed in claim 5, wherein said bearing plates are secured together by fasteners to thereby retain each of said bearing elements in their corresponding cavities.

7. Steering turntable as claimed in claim 6, wherein said bearing elements are spheroidal bearing elements having a curved outer surface.

8. Steering turntable as claimed in claim 7, wherein said cavities are defined by truncated curved surfaces terminating in openings in the outer surfaces of the bearing plates and engaging the outer surface of said bearing elements while permitting the bearing elements to extend through said openings and project from the outer surfaces of the bearing plates to engage said upper and lower support plates.

9. Steering turntable as claimed in claim 2, wherein said isolation plate includes a pair of parallel bearing plates each extending parallel to the other bearing plate and to said upper and lower support plates, each of said bearing plates defining an outer surface facing its corresponding upper or lower support plates, at least one of said bearing plates defining multiple apertures defining multiple cavities, each of said cavities supporting a bearing element, and fasteners securing said bearing plates together to thereby retain each of said bearing elements in their corresponding cavities.

10. Steering turntable as claimed in claim 9, wherein each of said bearing elements are defined by a curved surface, said cavities being defined by a truncated curved surface curved compatibly with the curved surface defining the bearing element whereby the curved surface of the aperture engages the curved surface of its corresponding bearing element when the latter is received therein, the curved surfaces defining said cavities terminating in an opening in the outer surface of the one bearing plate and permitting the bearing elements to extend through said opening and project from the outer surfaces of the one bearing plate to engage a corresponding one of the support plates.

11. Bearing isolation plate, comprising:
a pair of parallel bearing plates each extending parallel to the other bearing plate, each of said bearing plates defining an outer surface facing away from the outer surface defined by the other bearing plate, and further defining multiple registering apertures cooperating to define corresponding multiple cavities, each of said cavities supporting a bearing element; and
fasteners securing said bearing plates together to thereby retain each of said bearing elements in its corresponding cavity.

12. Bearing isolation plate as claimed in claim 11, wherein said cavities are defined by truncated curved surfaces terminating in openings in the outer surfaces of the bearing plates and engaging the outer surfaces of said bearing elements while permitting the bearing elements to extend through said openings and project from the outer surfaces of the bearing plates.

13. Bearing isolation plate as claimed in claim 11, wherein each of said bearing elements is defined by a curved surface, said cavities being defined by a truncated curved surface curved compatibly with the curved surface defining the bearing element whereby the curved surface of the aperture engages the curved surface of its corresponding bearing element when the latter is received therein, the curved surfaces defining said cavities terminating in openings in the outer surfaces of the bearing plates and permitting the bearing elements to extend through said openings and project from the outer surfaces of the bearing plates.

14. Turntable assembly, comprising:
a pair of members;
means pivotally connecting said members for rotation relative to one another; and
an isolation plate mounted between said pair of members to reduce steering forces required to steer an attached vehicle,
wherein said isolation plate carries multiple bearing elements, wherein said isolation plate has opposite sides each facing a corresponding one of said members, and wherein said bearing elements engage said pair of members.

15. Turntable assembly as claimed in claim 14, wherein said isolation plate includes a pair of parallel bearing plates each extending parallel to the other bearing plate and to said members, each of said bearing plates defining an outer surface facing its corresponding member and further defining multiple registering apertures cooperating to define corresponding multiple cavities, each of said cavities supporting a bearing element.

16. Turntable assembly as claimed in claim 15, wherein said cavities are defined by truncated curved surfaces terminating in openings in the outer surfaces of the bearing plates and engaging the outer surfaces of said bearing elements while permitting the bearing elements to extend through said openings and project from the outer surfaces of the bearing plates to engage said members.

17. Turntable assembly as claimed in claim 14, wherein said isolation plate includes a pair of parallel bearing plates each extending parallel to the other bearing plate and to said members, each of said bearing plates defining an outer surface facing its corresponding one of said members, at least one of said bearing plates defining multiple apertures defining multiple cavities, each of said cavities supporting a bearing element, and fasteners securing said bearing plates together to thereby retain each of said bearing elements in its corresponding cavity.

18. Turntable assembly as claimed in claim 17, wherein each of said bearing elements is defined by a curved surface, said cavities being defined by a truncated curved surface curved compatibly with the curved surface defining the bearing element, whereby the curved surface of the cavity engages the curved surface of its corresponding bearing element when the latter is received therein, the curved surfaces defining said cavities terminating in an opening in the outer surface of the one bearing plates and permitting the bearing elements to extend through said opening and project from the outer surfaces of the one bearing plate to engage a corresponding one of the members.
